(19) United States
(12) Patent Application Publication
(10) Pub. No.: US 2020/0065835 A1
(43) Pub. Date: Feb. 27, 2020

(54) CUSTOMER FRUSTRATION SCORE GENERATION AND METHOD FOR USING THE SAME

(71) Applicant: QUANTIPLY CORPORATION, San Jose, CA (US)

(72) Inventors: Ankur Manikandan, San Jose, CA (US); Qike Li, San Jose, CA (US); Shaarvani Kavula, San Jose, CA (US); Surendra Reddy, Palo Alto, CA (US); Jagadish Changavi, San Jose, CA (US); Vamsi Koduru, San Jose, CA (US)

(21) Appl. No.: 16/452,180

(22) Filed: Jun. 25, 2019

Related U.S. Application Data
(63) Continuation of application No. 16/391,143, filed on Apr. 22, 2019.
(60) Provisional application No. 62/721,746, filed on Aug. 23, 2018.

(51) Int. Cl. G06Q 30/02; G06F 16/22

(52) U.S. Cl. CPC G06Q 30/0201; G06F 16/2228

(57) ABSTRACT

A method and apparatus for generating and/or using a customer frustration score are disclosed. In one embodiment, the method comprises generating a customer frustration index for a customer; and performing one or more operations based on the customer frustration index.

### PRIORITY

The present application is a continuation of and claims benefit of U.S. patent application Ser. No. 16/391,143, titled “Customer Frustration Score Generation and Method for Using the Same,” filed Apr. 22, 2019 which claims the benefit under 35 USC 119(e) of U.S. Provisional Patent Application No. 62/721,746 filed Aug. 23, 2018 and is incorporated by reference in its entirety.

### BACKGROUND OF THE INVENTION

Today, businesses are interested in determining their customer satisfaction with respect to engagements that occur between customers and the company and its representatives (e.g., customer service representatives). As many companies offer products and services to customers, companies are always trying to determine if the consumer is using all of these products and services, including how are they using these services, when they are using these services or products, and how satisfied they are with those products and services.

There is always the possibility that the customer becomes frustrated with a product or service for a variety of reasons that include, for example, from how much a product cost, functionality issues (e.g., log-in problems), etc. In addition to offering products and services, companies often have a support team to help customers in case there are any issues with the products or services. During that process of trying to resolve issues with the customer representative, customers can become quite frustrated with getting issues addressed by the company or its representatives. This frustration could go up or down depending on how the interaction with the customer is transpiring. A customer may become so frustrated that they decide to stop interacting with the company and its products. At this point, the company has lost a customer, which companies want to avoid.

### SUMMARY

A method and apparatus for generating and/or using a customer frustration score are disclosed. In one embodiment, the method comprises generating a customer frustration index for a customer; and performing one or more operations based on the customer frustration index.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 is a block diagram of one embodiment of a control system that is controlled via a customer frustration index.

FIG. 2 is a block diagram of one embodiment of a customer frustration index generator.

FIG. 3 illustrates an example of collaborative filtering generating a matrix.

FIG. 4 is a block diagram of a system architecture for use with the techniques described herein.

FIG. 5 is a data flow diagram of one embodiment of a process for generating and using a customer frustration index.

FIG. 6 is a block diagram of a computer system that may be used to implement one or more functions described herein.

### DETAILED DESCRIPTION OF THE PRESENT INVENTION

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

### Overview

An apparatus for generating a customer index and a method for using the same are described. In one embodiment, the customer index, or score, represents a customer's frustration level. In one embodiment, this customer frustration index, C/Fix, represents a customer's frustration level based on a customer's historical data. In one embodiment, the techniques described herein encapsulate the frustration of a customer. The techniques use metrics to understand whether the customer's sentiment is positive, neutral, or negative. This enables actionable insights to the company. These actionable insights may indicate how the company can improve their customer support processes, allow understanding as to what the customer really wants, and/or may indicate that a customer service representative to intervene even before the customer reaches a specific frustration level. That is, these actionable insights are provided to the customer representatives and to the company so that they can take necessary actions to ensure that the customer is always satisfied, is positively satisfied, is positively engaging with their brand and is always continuing to associate with their brand. In this way, one can be ensured that the customer support process is improving so that at the end of the day the customers are happy and always have a positive sentiment associated to either a product or a service.

Once the customer index is generated, the customer frustration index is received by a controller to control business processing logic. In one embodiment, the business processing logic controls visualizations. In one embodiment, the visualizations allow a company and/or its customer service representatives to determine the state of a customer and/or enable a better response to the customer. For example, the customer frustration index can indicate that more attention needs to be given to a particular customer with a high frustration level since they are more likely to close their accounts. Note such visualizations have additional uses. In one embodiment, the visualizations may be used by members from other businesses. For example, a product team can look at one or more dashboards containing the customer frustration index to identify products/product features of which customers are getting most frustrated. Also, a sales team can also leverage such dashboards to recommend new products and/or services.

Furthermore, customer representatives in addition to the CFix scores can prioritize customers based on the customer tier bucket (e.g., customers in bronze, platinum, and gold tiers, etc.). In one embodiment, different customer tier buckets are visualized in different colors on the customer service representative's visualization dashboard. By doing so, if two customers, one in the platinum tier and the other in the bronze tier, have the same frustration score, the customer service representative can give priority to the higher (e.g., platinum) tier customer. Thus, companies can prioritize their high worth or otherwise more important customers relative to other customer tier categories.

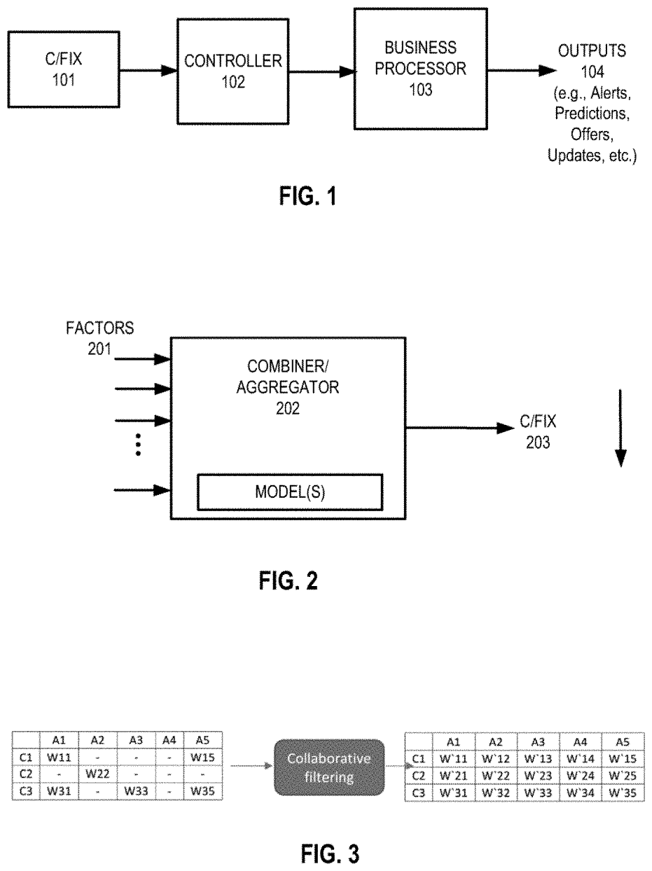

FIG. 1 is a block diagram of one embodiment of a control system that is controlled via a customer frustration index. The system includes processing logic that may comprise hardware (circuitry, dedicated logic, etc.), software (such as is run on a general-purpose computer system, a server or a dedicated machine), firmware, or a combination of the three.

Referring to FIG. 1, a controller 102 receives consumer frustration index 101. In one embodiment, consumer frustration index 101 is generated by combining and/or aggregating data from multiple sources. These sources may be business-related sources and/or non-business-related sources. In response to consumer frustration index 101, controller 102 sends signals to business processor 103 to cause business processor 103 to take actions related to the customer. These actions may include updating one or more visualizations used by customer service representatives of the company, generating and sending notifications related to the customer to one or more individuals of the company (e.g., customer service representatives, salesman, etc.), generating and providing predictions and/or offers for goods and/or services with respect to the customer. In one embodiment, these actions are automatically taken.

In another embodiment, the actions include acknowledging a customer for using the company's services/products via a communication (e.g., email, text message, phone call, etc.). If a customer has been identified that is having some technical issues and their frustration is growing, then an automatic email can be sent with instructions on addressing their issue (e.g., how to debug the technical issues). Furthermore, in one embodiment, if a customer has been consistently trying to find specific information about a product/service and if they aren't able to find the information easily (causing their frustration to keep growing as indicated by the customer frustration index), then a communication (e.g., an email) is automatically sent the desired information or some FAQs.

Examples of Factors to Generate a Customer's Frustration Index

As discussed above, in order to optimize the customer support process, a score, referred to herein as the customer frustration index, is generated that represents the customer's frustration level. In one embodiment, this customer frustration index captures multiple aspects of a customer. In one embodiment, the customer frustration index captures three aspects of a customer. The first aspect is a customer's sentiment. The second is a temporal pattern. The third is the customer's behavior pattern. Another aspect that impacts a customer's frustration score is the brand loyalty of a customer. For a customer that's very loyal to a brand, even if the customer is experiencing some negative experience, the customer may still stay with the company.

In one embodiment, the computation of C/Fix considers the following factors:

1) Customer's sentiment. In one embodiment, a customer's sentiment is reflected from a customer's interactions with the customer representative. In one embodiment, each interaction is scored and the scored interactions are combined into a single customer sentiment score. In one embodiment, the interactions are in the form of communications. These communications with customer representatives include, but are not limited to, text and email messages, live chat logs, phone calls, secure messages, and voicemail messages. In one embodiment, all voice related recording is transcribed into text. In one embodiment, the text from these communications is analyzed to determine their sentiment. In one embodiment, the text is analyzed using natural language processing (NLP) and/or Natural Language Understanding (NLU), based on customer's behavioral pattern with respect to their text interaction with the company. Sentiment may go up and down quickly; however, depending on the customer, that might not be indicative of their overall impression of a company's products or services of whether that person is going to leave as the person may be, for example, short-tempered. In one embodiment, the sentiment factor is also based on the length of each interaction. For example, longer interactions may influence the sentiment factor more than shorter interactions, or vice versa. In one embodiment, the customer frustration index generator determines whether the sentiment is positive, neutral or negative.

2) Temporal pattern. In one embodiment, the earlier an event or interaction took place, the more it is discounted. That is, in one embodiment, when interactions occur more recently, the customer frustration index is influenced more than by an interaction that occurred long ago. For example, interactions that occur more recently have more influence on the customer frustration index than interactions that occurred long ago.

3) Behavioral pattern. In one embodiment, a sharper increase in a customer's frustration level implies a higher likelihood that the customer will no longer be a customer (e.g., a customer that is closing accounts, a customer that no longer buys and/or uses the company's products and services, etc.), and a sharp decrease of a short-tempered customer's sentiment is less dangerous than that of a moderate customer when it comes to the possibility of a customer ending their relationship with the company.

4) Brand loyalty index. In one embodiment, the brand loyalty index is a measure of the loyalty of a customer to the company. The inclusion of this feature enables the customer frustration index to take into consideration the customer's attitude towards the company itself In one embodiment, the assumption is that a brand loyal customer is one that uses more products and services of the company.

Note that in alternative embodiments, the customer frustration index is based on only a subset of these four factors. Also, in alternative embodiments, the customer frustration index is based on these four factors plus additional factors. In one embodiment, one or more of the following factors are used: customer tier categories, customer demographic data, customer social-economic data, customer life time value and other customer behavioral data.

FIG. 2 is a block diagram of one embodiment of a customer frustration index generator. The customer frustration index generator includes processing logic that may comprise hardware (circuitry, dedicated logic, etc.), software (such as is run on a general-purpose computer system, a server or a dedicated machine), firmware, or a combination of the three.

Referring to FIG. 2, a combiner/aggregator 202 combines data from a plurality of factors 201 to generate a customer frustration index 203. In one embodiment, factors 201 include three factors. In alternative embodiments, factors 201 includes more or less than three factors. In one embodiment, combiner/aggregator 202 combines factors 201 using one or more models. In one embodiment, the one or more models include an ensemble of models (e.g., a linearly weighted model stack, bagging, etc.).

### Weighted Linear Stacking

In one embodiment, the C/Fix score is determined by using an ensemble method. In one embodiment, the ensemble method applies a linearly weighted model stack approach and uses the scores from each model to determine the C/Fix score.

In one embodiment, the linearly stacked ensemble contains the following models:
1. Customer sentiment-progression model
2. Customer behavior model
3. Brand loyalty index model

In one embodiment, the C/Fix score is determined as follows:

C/Fix=weight₁*Customer sentiment-progression model+weight₂*Customer behavior model−weight₃*Brand loyalty index model,

where weight₁, weight₂ and weight₃ are weights that are tuned.

### Compute Customer Frustration Index (C/Fix)

In one embodiment, the customer frustration index is determined using three terms according to the following:

$$C / Fix = \frac{1}{{\sum }_{n = 0}^{n = N} {γ}^{{t}_{N} - {t}_{n}}} {\sum }_{n = 0}^{n = N} {γ}^{{t}_{N} - {t}_{n}} {S}_{n} + λ \frac{{S}_{N} - {S}_{N - 1}}{sd ( S )} - η {\sum }_{m = 0}^{m = M} {\tilde{p}}_{m} γ ∈ [ 0 , 1 ] ;$$

$$λ ∈ [ 0 , ∞ ) ; η ∈ [ 0 , ∞ )$$

The three terms,

$$\frac{1}{{\sum }_{n = o}^{n = N} {γ}^{{t}_{N} - {t}_{n}}} {\sum }_{n = 0}^{n = N} {γ}^{{t}_{N} - {t}_{n}} {S}_{{n}^{′}} \frac{{S}_{N} - {S}_{N - 1}}{sd ( S )} , {\sum }_{m = 0}^{m = M} {\tilde{p}}_{m} ,$$

in the above calculation of C/Fix correspond to a customer's sentiment-progression pattern, behavioral pattern, and brand loyalty index, respectively.

Regarding timing parameters, t₀ is the time of first event, t₀ is set as 0 for all customers, and tₙ represents n^{th} event. If an event takes place on day 125, then tₙ=125. t_{N} represents the latest event. Sₙ represents the sentiment score at time tₙ.

The equation above includes a number of tuning parameters. For example, γ is a tuning parameter. When γ=0, the score is memoryless. When γ=1, the first term of C/Fix score is a cumulative mean. When γ∈(0,1), earlier events are discounted at the rate of γ.

In the second term, sd(S) represents the standard deviation of the sentiment scores from the past N events. In one embodiment, a short-tempered customer tends to have a large sd(S). Thus, if there has been a sharp decrease in a customer's sentiment, more attention may be given to a customer and this would be represented with the numerator, while the denominator of the second term represents the customer's variation in temper. Also, the tuning parameter λ indicates the emphasis put on the behavioral pattern. In one embodiment, the larger the λ, the more emphasis is put on the behavioral pattern.

In the third term, \tilde{p}ₘ represents the number of times the m^{th} workflow a customer might have done, while η represents the emphasis put on the brand loyalty behavioral pattern.

Note that the subtraction of the third factor from the sum of the other two factors in the equation above causes a more loyal customer to have a customer frustration index lower than that a customer with the same first two factors yet is less of a brand loyal customer. In other words, the less brand loyal customer in those circumstances would have a customer frustration index indicating they are more unsatisfied (or more frustrated).

In one embodiment, the three tuning parameters γ, λ, and η represent the weights that are used to combine the factors. In one embodiment, these three tuning parameters γ, λ, and η are tuned based on AB testing. The tuning may occur dynamically as new data becomes available. In an alternative embodiment, the tuning is performed at regular intervals. These regular intervals could be based on time, such as, for example, but not limited to, every hour, every day, every week, etc. Alternatively, these regular intervals could be based on the amount of data that have been received since the last update. For example, if a certain threshold amount of new data has been received, the tuning of the tuning parameters may be performed. Also, in one embodiment, the tuning is performed according to the particular industry of the company and its customers.

### An Example of a Brand Loyalty Index Model

In one embodiment, the brand loyalty index model in the index generation subsystem uses a customer-activity matrix F where each row represents a customer and each column represents an activity. Note that not all customers interact with all of the company's products or services. Therefore, the customer-activity matrix P will have some missing information. In on embodiment, customers with similar behavior and interests are more likely to use the same products/services.

In one embodiment, the index generation subsystem applies a collaborative filtering algorithm, such as, for example, but not limited to, singular value decomposition (SVD), to reconstruct the matrix \tilde{P}. In one embodiment, each element in matrix \tilde{P} indicates the times of the number of times the product/services a customer might have used out of M total services. The total number of the products/services that a customer might have used strongly indicates a customer's loyalty.

In one embodiment, once the index generation subsystem has a complete matrix, the index generation subsystem sums up the values in matrix \tilde{P} for each row as a brand loyalty index score. FIG. 3 illustrates an example of the summing process.

### Model Tuning

As discussed above, in one embodiment, the parameters/weights and a tuning process are used to obtain good estimates for the values. In order to tune the models, in one embodiment, end users play a critical role in helping determine the best values for the tuning parameters. In one embodiment, the C/FIX score is determined in a very flexible manner.

In one embodiment, the ensemble model is run on many servers, where each ensemble model has a different value assigned to the tuning parameter.

In one embodiment, the results of the different ensemble models are presented to different groups of end users. End users feedback information in response to the presented results observed from the models, which is incorporated back into the ensemble by changing the values of the tuning parameters. This approach is referred to herein as A/B testing and is well-known in the art. By leveraging A/B testing, one can quickly iterate through different values of the tuning parameters to obtain a more accurate ensemble model.

### Business Value of Each Term in the CFix Score

Each term of the CFix score is associated with a business value. In one embodiment, business values associated with each term are given below.
1. Customer Sentiment-Progression Score
   a. How often does the customer interact with the ecosystem?
   b. Time analysis of sentiment scores of the customer
2. Behavior Score
   a. Customer's attitude towards the business
   b. Pattern Analysis of Customer behavior with time
3. Brand Loyalty Score
   a. Customer's purchase and dedication to different products or services
   b. Customer activity analysis from the time an account was created with the business

### Business Value of Each Term in the CFix Score

c. Holistic view of customer's behavior towards the business
d. Change in CFix score will help understand the areas of focus to improve
e. Product recommendations based on customer intention
f. Price offerings that suit customer's financial and behavioral profiles.

Once a customer frustration index is generated, the score is fed into the controller subsystem. In one embodiment, in response to the customer frustration index, the controller automatically causes one or more system actions to occur.

In one embodiment, the customer frustration index is included as part of the customer's genome. In one embodiment, this genome is a mapping to the semantic map like that X and Y matrix, where each of the cells represents one particular trait of this customer. Once the cells are populated, the genome represents a unique fingerprint of the customer. In other words, the genome is a semantic coding of customer behavioral patterns. In one embodiment, the genome along with the customer frustration index is used to drive business logic to increase customer satisfaction and customer profitability. In one embodiment, the business logic uses the genome to predict customer actions.

In one embodiment, the final CFIX score is stored in a database and can be visualized on a display system. It could be used to visualize the results and these results could be used for different purposes. These visualizations a holistic view of the customer's behavior towards the business and can be used to understand the areas of improvement needed to reduce the customer's frustration and overall give them like a happy experience.

Also, using this information, the company can offer targeted products that excite the customer and engage the customer with the business. Furthermore, the pricing of the product offerings can be set and/or adjusted based on customer's financial and behavioral profiles.

In one embodiment, the customer frustration index is presented on a customer activity timeline. The customer activity timeline provides a single snapshot that gives us the holistic view of how a customer is interacting with the company's eco-system. In one embodiment, this snapshot may indicate that the customer's interaction with the company and its representatives is positive or negative. In one embodiment the customer activity timeline is used by a customer service representative when interacting with the customer to enable them to be able to quickly access past interactions.

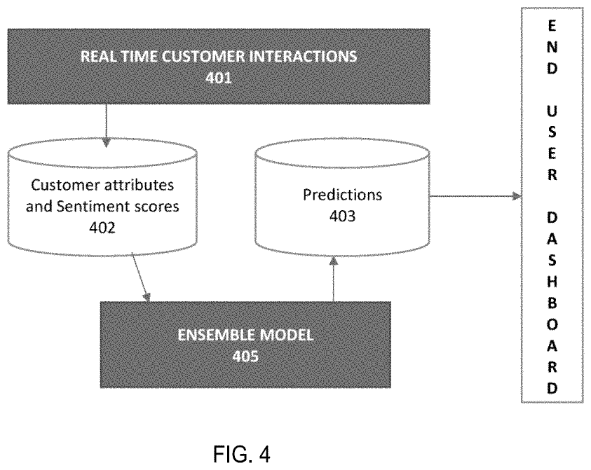

FIG. 4 is a block diagram of one embodiment of one system architecture. The system architecture includes processing logic that may comprise hardware (circuitry, dedicated logic, etc.), software (such as is run on a general-purpose computer system, server, or a dedicated machine), firmware, or a combination of the three. Note that the architecture of FIG. 4 may be used for offline computations or real-time computations.

Referring to FIG. 4, when customers interact with the business, data corresponding to the real-time interactions 401 is captured and stored in a user data database 402. In one embodiment, the data from the customer real-time interactions 401 is stored in database 402. In one embodiment, the data includes customer attributes and sentiment scores. The data corresponding to the customer attributes and sentiment scores is fed directly to ensemble model 405. In one embodiment, ensemble model 405 generates the customer frustration index in real-time based on data from all previous customer interactions or a subset thereof In another embodiment, ensemble model 405 generates CFix scores, which are stored in predictions database 403. Data from predictions database 403 is provided to an end user dashboard or other user interface.

In one embodiment, the predictions are made at least in part based on the genome associated with each customer.

As stated above, the generation of both the customer frustration index and the predictions can occur in either or both on-line or off-line modes. In one embodiment, with offline computations, the customer attributes data are stored in a database and the CFix computations are scheduled to occur at any time, such as, for example, but not limited to, every hour, end of every day, end of a week and so on. The same architecture can be leveraged to also perform real time computations. In such a case, in one embodiment, the moment a customer interacts with a product or service, the end user dashboard will be updated with the latest/most recent score.

With respect to the predictions, these may be sent directly to the end users. These predictions may include offers for goods and/or services for the customer. In one embodiment, notifications related to the customer are generated and sent to one or more individuals of the company (e.g., customer service representatives, salesman, etc.). In one embodiment, these actions are automatically taken.

In one embodiment, one or more other actions occur automatically. These may include acknowledge customer's for using the company's services/products via a communication (e.g., an email, text messages, phone call, etc.). If a customer has been identified that is having some technical issues and their frustration is growing, then an automatic email can be sent with instructions on addressing their issue (e.g., how to debug the technical issues). Furthermore, in one embodiment, if a customer has been consistently trying to find specific information about a product/service and if they aren't able to find the information easily (causing their frustration to keep growing as indicated by the customer frustration index), then a communication (e.g., an email) is automatically sent the desired information or some FAQs.

In one embodiment, ensemble model 405 operating on one processing device (e.g., a server). However, in another embodiment, there are multiple ensemble models and they run on one or more servers. Each ensemble model may be dedicated to a specific group, industry, and/or company. Thus, in such a case, predictions can be made for a specific group.

Also, in one embodiment, each factor is generated using a separate server or machine, along with the tuning of their associated tuning parameter. Using feedback to the separate servers, each of the tuning parameters can be set.

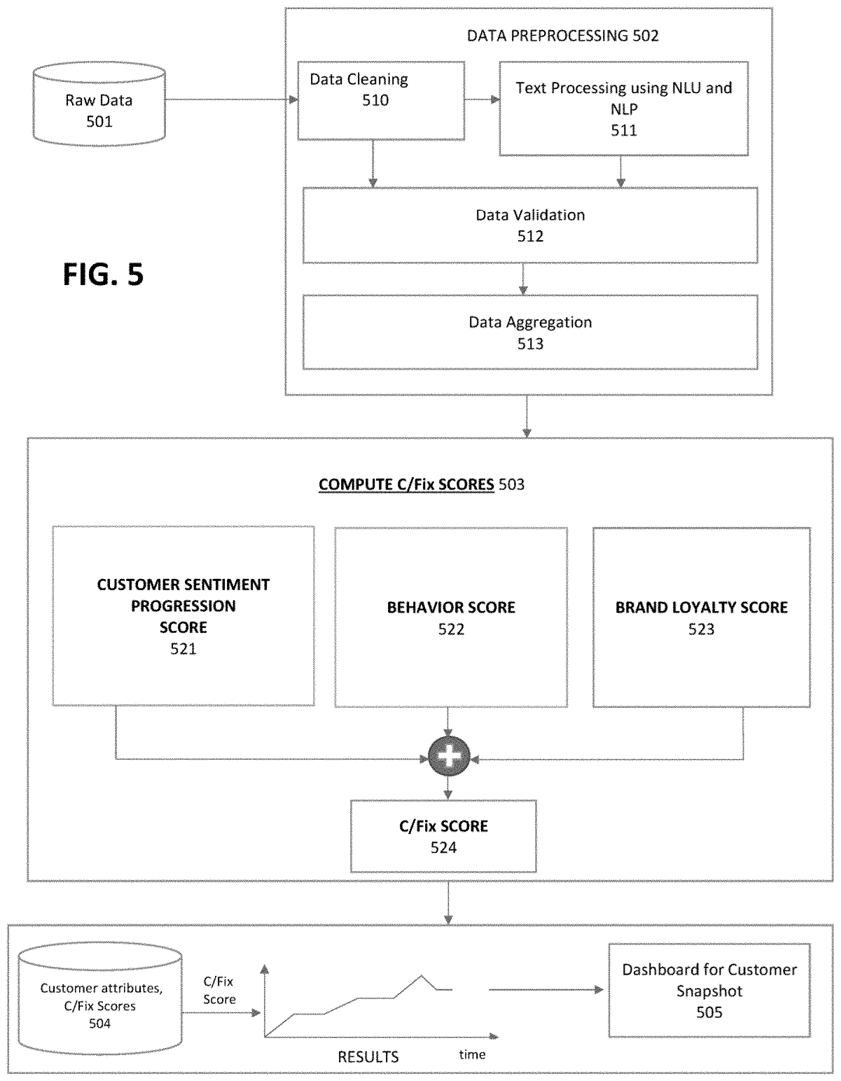

FIG. 5 is a data flow diagram of one embodiment of a process for generating and using a customer frustration index. The process is performed by processing logic that may comprise hardware (circuitry, dedicated logic, etc.), software (such as is run on a general-purpose computer system, server, or a dedicated machine), firmware, or a combination of the three.

Referring to FIG. 5, the process begins by performing data preprocessing 502 on raw data 501. In one embodiment, raw data 501 comprises customer data, such as, for example, but not limited to, customer interaction data. Data preprocessing 502 cleans the data (510) (e.g., missing nulls, imputation, etc.) and processes text data (511). In one embodiment, data preprocessing 502 processes text data using natural language understanding (NLU) or natural language processing (NLP). In one embodiment, the output of the text processing is sentiment scores related to each of the customer interactions. In one embodiment, the sentiment scores are positive, neutral or negative scores.

The results of cleaning the data (510) and processing the text data (511) are validated via data validation (512). In one embodiment, the data validation process checks whether the data is in the proper format and corrects the format if cases where the data is not in the proper format. In one embodiment, sentiment scores are also mapped to a customer identifier (ID).

After validation and mapping, the customer sentiment scores are aggregated (513). In one embodiment, the aggregation includes integrated the customer sentiment scores into a customer table or other data structure for use in creating the customer frustration index.

Next, the consumer frustration index (score) is generated (503). During the process of generating the consumer frustration index, a customer sentiment progression score 521, a behavior score 522, a brand loyalty score 523 are all generated and combined to generate the C/Fix score 524. In one embodiment, the customer sentiment progression score 521 is generated by calculating the total number of interactions until the current time and calculating the aggregated sentiment scores from previous interactions. In one embodiment, the behavior score 522 is generated by calculating the difference between the values of the previous sentiment score and the current sentiment score and calculating the standard deviation of the sentiment scores until the current time. In one embodiment, the brand loyalty score 523 is generated by applying a collaborative filtering method on customer activity data and summing the customer activity vector after collaborative filtering. After the customer sentiment progression score 521, behavior score 522 and brand loyalty score 523 are generated, the weights of the customer sentiment progression score 521, behavior score 522 and brand loyalty score 523 are tuned, applied to scores 521-523, and the adjusted (tuned) scores 521-523 are aggregated for the final C/Fix score 524.

Once the final C/Fix score 524 is generated, the data processing system stores it in a database or storage (524) where it is accessible and used by other business processing logic, such as, for example, display as part of a visualization on a customer dashboard (505).

Note that there are a number of applications or other processing logic that may use the C/Fix score. In one embodiment, the C/Fix score is sent automatically to such applications and processing logic as an input. Alternatively, such applications and processing logic access the C/Fix score from a memory. This access may occur at regular times during execution or in response to an interrupt or other notification indicating that such a score is available or has been changed. For example, in one embodiment, the C/Fix score is used by any customer-service oriented business and is applicable to any product or service providing industry. In such a case, the C/Fix score is calculated using structured, semi-structured and/or unstructured data. In multiple embodiments, the C/Fix score is used by businesses for the following purposes:
1) to understand the most valuable customers of a business based off the customer's transaction history, user experience and product/service ratings by the customer;
2) to obtain the customer satisfaction score and know how happy/unhappy the customer is with the business. With progression of time, using the C/Fix score a business can also learn if a customer is loyal to the brand or business. Thus, in one embodiment, an application or processing logic can receive the C/Fix score and determine automatically their associated brand or business loyalty and on one or more incentives and/or offers that are sent, via a network (e.g., Internet) to the customer based on the determined loyalty. In one embodiment, such an application or processing logic accesses one or more databases using the C/Fix score or a determined loyalty (e.g., score, indication) with other customer information to identify the incentives and/or offers to be made to the customer. In one embodiment, an AI based or machine learning system receives C/Fix scores and/or determined loyalty indications or scores along with other data a multiple customers and generates a list of incentives or offers to send to customers using, for example, a network (e.g., Internet), messaging (e.g., SMS messages, email messages, etc.).
3) combine C/Fix scores of customers with product information can be used to evaluate products or services that are performing poorly. This information can be used to enhance a product/service to improve overall product reliability;
4) based off the C/Fix score, customer service teams can be assessed on how effective the teams have been with resolving customer queries and how satisfied the customers are with the overall turnaround time for their issues to be resolved. In one embodiment, a tracking application receives the scores along with other data relevant to the evaluation of the customer service terms and, using predefined criteria, produces an output indicative of how each customer service team is performing;
5) with time, use the C/Fix scores to analyze what can be done on the most common issues that the customers face to decrease customer dissatisfaction and improve areas in product/service to avoid customer dissatisfaction; and
6) use the C/Fix scores to determine a customer's satisfaction in the course of time. In one embodiment, an application or processing logic receives the C/Fix scores and calculates a change in the C/Fix score over time, which is equated to a change in the customer's view of the product. A tracking algorithm run by the an application or processing logic is used to track if there has been any improvement or deterioration in the products/services offered by a business. The calculation of change in C/Fix scores will help the business focus on the problem areas of a product/service which will in turn elevate the satisfaction of customers.

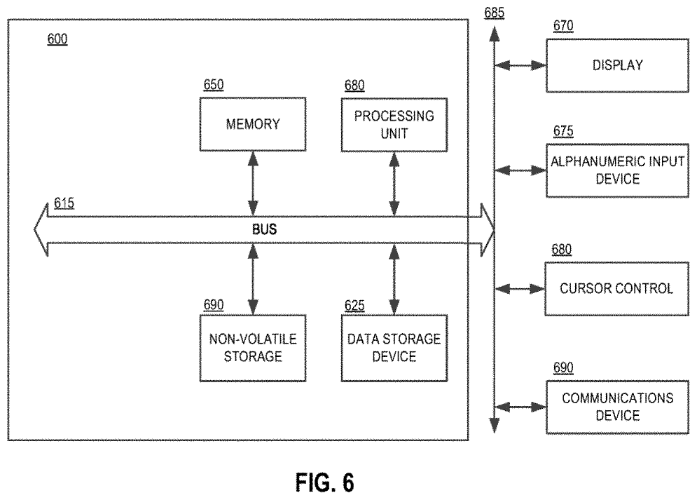

FIG. 6 is one embodiment of a computer system that may be used to support the systems and operations discussed herein. It will be apparent to those of ordinary skill in the art, however that other alternative systems of various system architectures may also be used.

The data processing system illustrated in FIG. 6 includes a bus or other internal communication means 615 for communicating information, and a processor 610 coupled to the bus 615 for processing information. The system further comprises a random access memory (RAM) or other volatile storage device 650 (referred to as memory), coupled to bus 615 for storing information and instructions to be executed by processor 610. Main memory 650 also may be used for storing temporary variables or other intermediate information during execution of instructions by processor 610. The system also comprises a read only memory (ROM) and/or static storage device 620 coupled to bus 615 for storing static information and instructions for processor 610, and a data storage device 625 such as a magnetic disk or optical disk and its corresponding disk drive. Data storage device 625 is coupled to bus 615 for storing information and instructions.

The system may further be coupled to a display device 670, such as a light emitting diode (LED) display or a liquid crystal display (LCD) coupled to bus 615 through bus 665 for displaying information to a computer user. An alphanumeric input device 675, including alphanumeric and other keys, may also be coupled to bus 615 through bus 665 for communicating information and command selections to processor 610. An additional user input device is cursor control device 680, such as a touchpad, mouse, a trackball, stylus, or cursor direction keys coupled to bus 615 through bus 665 for communicating direction information and command selections to processor 610, and for controlling cursor movement on display device 670.

Another device, which may optionally be coupled to computer system 600, is a communication device 690 for accessing other nodes of a distributed system via a network. The communication device 690 may include any of a number of commercially available networking peripheral devices such as those used for coupling to an Ethernet, token ring, Internet, or wide area network. The communication device 690 may further be a null-modem connection, or any other mechanism that provides connectivity between the computer system 600 and the outside world. Note that any or all of the components of this system illustrated in FIG. 6 and associated hardware may be used in various embodiments as discussed herein.

It will be appreciated by those of ordinary skill in the art that any configuration of the system may be used for various purposes according to the particular implementation. The control logic or software implementing the described embodiments can be stored in main memory 650, mass storage device 625, or other storage medium locally or remotely accessible to processor 610.

It will be apparent to those of ordinary skill in the art that the system, method, and process described herein can be implemented as software stored in main memory 650 or read only memory 620 and executed by processor 610. This control logic or software may also be resident on an article of manufacture comprising a computer readable medium having computer readable program code embodied therein and being readable by the mass storage device 625 and for causing the processor 610 to operate in accordance with the methods and teachings herein.

The embodiments discussed herein may also be embodied in a handheld or portable device containing a subset of the computer hardware components described above. For example, the handheld device may be configured to contain only the bus 615, the processor 610, and memory 650 and/or 625. The handheld device may also be configured to include a set of buttons or input signaling components with which a user may select from a set of available options. The handheld device may also be configured to include an output apparatus such as a liquid crystal display (LCD) or display element matrix for displaying information to a user of the handheld device. Conventional methods may be used to implement such a handheld device. The implementation of embodiments for such a device would be apparent to one of ordinary skill in the art given the disclosure as provided herein.

The embodiments discussed herein may also be embodied in a special purpose appliance including a subset of the computer hardware components described above. For example, the appliance may include a processor 610, a data storage device 625, a bus 615, and memory 650, and only rudimentary communications mechanisms, such as a small touch-screen that permits the user to communicate in a basic manner with the device. In general, the more special-purpose the device is, the fewer of the elements need be present for the device to function.

There are a number of example embodiments disclosed herein.

Example 1 is a method comprising: generating a customer frustration index for a customer; and performing one or more operations based on the customer frustration index.

Example 2 is the method of example 1 that may optionally include that generating the customer frustration index comprises combining data related to one or more of sentiment, a temporal pattern, a behavior pattern and brand loyalty of the customer.

Example 3 is the method of example 2 that may optionally include that the data includes interaction data related to interactions with the customer.

Example 4 is the method of example 3 that may optionally include that the interaction data comprises text data from one or more of a text message, an email message, a chat session, a telephone call, a voicemail message, secure messages, secure alerts, and search.

Example 5 is the method of example 2 that may optionally include that the brand loyalty is represented by a brand loyalty index.

Example 6 is the method of example 2 that may optionally include that generating the customer frustration index comprises tuning a plurality of factors that are combined into the customer frustration index.

Example 7 is the method of example 2 that may optionally include that generating the customer frustration index comprises: applying a customer sentiment-progression model to sentiment data taking into account its progression or temporal pattern; applying a customer behavior model to behavioral data; applying a brand loyalty index model to brand loyalty data; and using scores output from the customer sentiment-progression model, the customer behavior model, and the brand loyalty index model to create the customer frustration index.

Example 8 is the method of example 2 that may optionally include that generating the customer frustration index comprises: calculating a total number of interactions until a current time and calculating aggregated sentiment scores from previous interactions to generate a sentiment-progression score; calculating a difference between values of the previous sentiment score and the current sentiment score and calculating a standard deviation of the sentiment scores until the current time to generate a behavior score; applying a collaborative filtering method on customer activity data and summing a customer activity vector after collaborative filtering to generate a brand loyalty score; tuning weights of the sentiment-progression score, the behavior score and the brand loyalty score; applying weights to the sentiment-progression score, the behavior score and the brand loyalty score; and aggregating weighted scores to create the customer frustration index.

Example 9 is a system comprising: a memory to store data related to a customer; a customer frustration index generator for generating a customer frustration index for a customer; and a controller to perform one or more business logic operations based on the customer frustration index.

Example 10 is the system of example 9 that may optionally include that the customer frustration index generator is operable to generate the customer frustration index by combining data related to one or more of sentiment, a temporal pattern, a behavior pattern and brand loyalty of the customer.

Example 11 is the system of example 10 that may optionally include that the data includes interaction data related to interactions with the customer.

Example 12 is the system of example 11 that may optionally include that the interaction data comprises text data from one or more of a text message, an email message, a chat session, a telephone call, a voicemail message, secure messages, secure alerts, and search.

Example 13 is the system of example 10 that may optionally include that the brand loyalty is represented by a brand loyalty index.

Example 14 is the system of example 10 that may optionally include that the customer frustration index generator is operable to generate the customer frustration index by tuning a plurality of factors that are combined into the customer frustration index.

Example 15 is the system of example 10 that may optionally include that the customer frustration index generator is operable to generate the customer frustration index by: applying a customer sentiment-progression model to sentiment data taking into account its progression or temporal pattern; applying a customer behavior model to behavioral data; applying a brand loyalty index model to brand loyalty data; and using scores output from the customer sentiment-progression model, the customer behavior model, and the brand loyalty index model to create the customer frustration index.

Example 16 is the system of example 10 that may optionally include that the customer frustration index generator is operable to generate the customer frustration index by: calculating a total number of interactions until a current time and calculating aggregated sentiment scores from previous interactions to generate a sentiment-progression score; calculating a difference between values of the previous sentiment score and the current sentiment score and calculating a standard deviation of the sentiment scores until the current time to generate a behavior score; applying a collaborative filtering method on customer activity data and summing a customer activity vector after collaborative filtering to generate a brand loyalty score; tuning weights of the sentiment-progression score, the behavior score and the brand loyalty score; applying weights to the sentiment-progression score, the behavior score and the brand loyalty score; and aggregating weighted scores to create the customer frustration index.

Example 17 is an article of manufacture having one or more non-transitory computer readable media storing instruction thereon which, when executed by a system, cause the system to perform a method comprising: generating a customer frustration index for a customer; and performing one or more operations based on the customer frustration index.

Example 18 is the article of manufacture of example 17 that may optionally include that generating the customer frustration index comprises combining data related to one or more of sentiment, a temporal pattern, a behavior pattern and brand loyalty of the customer.

Example 19 is the article of manufacture of example 17 that may optionally include that the data includes interaction data related to interactions with the customer, and further wherein the interaction data comprises text data from one or more of a text message, an email message, a chat session, a telephone call, a voicemail message, secure messages, secure alerts, and search.

Example 20 is the article of manufacture of example 17 that may optionally include that generating the customer frustration index comprises: applying a customer sentiment-progression model to sentiment data taking into account its progression or temporal pattern; applying a customer behavior model to behavioral data; applying a brand loyalty index model to brand loyalty data; and using scores output from the customer sentiment-progression model, the customer behavior model, and the brand loyalty index model to create the customer frustration index.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; etc.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

1. A method comprising:
generating a customer frustration index for a customer of a company representing a frustration level of the customer with respect to the company, wherein generating the customer frustration index is based on historical data of the customer including interactions of the customer with the company or its representatives and behavior of the customer with respect to the company; and
performing one or more operations based on the customer frustration index.

2. The method defined in claim 1 wherein generating the customer frustration index comprises combining data related to two or more of sentiment, a temporal pattern, a behavior pattern and brand loyalty of the customer.

3. The method defined in claim 2 wherein the data includes interaction data related to interactions with the customer.

4. The method defined in claim 3 wherein the interaction data comprises text data from one or more of a text message, an email message, a chat session, a telephone call, a voicemail message, secure messages, secure alerts, and search.

5. The method defined in claim 2 wherein the brand loyalty is represented by a brand loyalty index.

6. The method defined in claim 2 wherein generating the customer frustration index comprises tuning a plurality of factors that are combined into the customer frustration index.

7. The method defined in claim 2 wherein generating the customer frustration index comprises:
applying a customer sentiment-progression model to sentiment data taking into account its progression or temporal pattern;
applying a customer behavior model to behavioral data;
applying a brand loyalty index model to brand loyalty data; and
using scores output from the customer sentiment-progression model, the customer behavior model, and the brand loyalty index model to create the customer frustration index.

8. The method defined in claim 2 wherein generating the customer frustration index comprises:
calculating a total number of interactions until a current time and calculating aggregated sentiment scores from previous interactions to generate a sentiment-progression score;
calculating a difference between values of the previous sentiment score and the current sentiment score and calculating a standard deviation of the sentiment scores until the current time to generate a behavior score;
applying a collaborative filtering method on customer activity data and summing a customer activity vector after collaborative filtering to generate a brand loyalty score;
tuning weights of the sentiment-progression score, the behavior score and the brand loyalty score;
applying weights to the sentiment-progression score, the behavior score and the brand loyalty score; and
aggregating weighted scores to create the customer frustration index.

9. A system comprising:
a memory to store data related to a customer;
a customer frustration index generator for generating a customer frustration index for a customer of a company representing a frustration level of the customer with respect to the company, wherein the customer frustration index generator is operable to generate the customer frustration index is based on historical data of the customer including interactions of the customer with the company or its representatives and behavior of the customer with respect to the company; and
a controller to perform one or more business logic operations based on the customer frustration index.

10. The system defined in claim 9 wherein the customer frustration index generator is operable to generate the customer frustration index by combining data related to two or more of sentiment, a temporal pattern, a behavior pattern and brand loyalty of the customer.

11. The system defined in claim 10 wherein the data includes interaction data related to interactions with the customer.

12. The system defined in claim 11 wherein the interaction data comprises text data from one or more of a text message, an email message, a chat session, a telephone call, a voicemail message, secure messages, secure alerts, and search.

13. The system defined in claim 10 wherein the brand loyalty is represented by a brand loyalty index.

14. The system defined in claim 10 wherein the customer frustration index generator is operable to generate the customer frustration index by tuning a plurality of factors that are combined into the customer frustration index.

15. The system defined in claim 10 wherein the customer frustration index generator is operable to generate the customer frustration index by:
applying a customer sentiment-progression model to sentiment data taking into account its progression or temporal pattern;
applying a customer behavior model to behavioral data;
applying a brand loyalty index model to brand loyalty data; and
using scores output from the customer sentiment-progression model, the customer behavior model, and the brand loyalty index model to create the customer frustration index.

16. The system defined in claim 10 wherein the customer frustration index generator is operable to generate the customer frustration index by:
calculating a total number of interactions until a current time and calculating aggregated sentiment scores from previous interactions to generate a sentiment-progression score;
calculating a difference between values of the previous sentiment score and the current sentiment score and calculating a standard deviation of the sentiment scores until the current time to generate a behavior score;
applying a collaborative filtering method on customer activity data and summing a customer activity vector after collaborative filtering to generate a brand loyalty score;
tuning weights of the sentiment-progression score, the behavior score and the brand loyalty score;
applying weights to the sentiment-progression score, the behavior score and the brand loyalty score; and
aggregating weighted scores to create the customer frustration index.

17. An article of manufacture having one or more non-transitory computer readable media storing instruction thereon which, when executed by a system, cause the system to perform a method comprising:
generating a customer frustration index for a customer of a company representing a frustration level of the customer with respect to the company, wherein generating the customer frustration index is based on historical data of the customer including interactions of the customer with the company or its representatives and behavior of the customer with respect to the company; and
performing one or more operations based on the customer frustration index.

18. The article of manufacture defined in claim 17 wherein generating the customer frustration index comprises combining data related to two or more of sentiment, a temporal pattern, a behavior pattern and brand loyalty of the customer.

19. The article of manufacture defined in claim 17 wherein the data includes interaction data related to interactions with the customer, and further wherein the interaction data comprises text data from one or more of a text message, an email message, a chat session, a telephone call, a voicemail message, secure messages, secure alerts, and search.

20. The article of manufacture defined in claim 17 wherein generating the customer frustration index comprises:
applying a customer sentiment-progression model to sentiment data taking into account its progression or temporal pattern;
applying a customer behavior model to behavioral data;
applying a brand loyalty index model to brand loyalty data; and
using scores output from the customer sentiment-progression model, the customer behavior model, and the brand loyalty index model to create the customer frustration index.
